(19) United States
(12) Patent Application Publication
(10) Pub. No.: US 2026/0153672 A1
(43) Pub. Date: Jun. 4, 2026

(54) DISSIPATIVE ENGINEERING OF NON-HERMITIAN SKIN EFFECT PHOTONICS FOR NON-MAGNETIC CHIRAL OPTICAL COUPLERS

(71) Applicant: REGENTS OF THE UNIVERSITY OF MICHIGAN, Ann Arbor, MI (US)

(72) Inventors: Chulwon Lee, Ann Arbor, MI (US); Hui Deng, Ann Arbor, MI (US)

(21) Appl. No.: 19/409,565

(22) Filed: Dec. 4, 2025

Related U.S. Application Data
(60) Provisional application No. 63/728,054, filed on Dec. 4, 2024.

(51) Int. Cl. G02B 6/12; G02B 6/293

(52) U.S. Cl. CPC G02B 6/12007; G02B 2006/12104; G02B 6/29343

(57) ABSTRACT

An optical device is disclosed. The optical device includes a pair of optical waveguide structures forming an optical chiral router. The pair of optical waveguide structures includes a first optical waveguide structure formed of a first set of photonic crystal nanocavities, a second optical waveguide structure formed of a second set of photonic crystal nanocavities, the first optical waveguide structure being offset relative to the second optical waveguide structure to form auxiliary optical cavity modes, and one or more mirror regions positioned relative to the first optical waveguide structure and the second optical waveguide structure to induce a chiral skin effect based on loss-induced next-nearest neighbor coupling and Z2 symmetry breaking across the optical chiral router.

### CROSS-REFERENCE TO RELATED APPLICATIONS

This application claims the benefit of U.S. Application No. 63/728,054, filed Dec. 4, 2024, and entitled “Dissipative Engineering of Non-Hermitian Nonreciprocal Photonics for Nonmagnetic Optical Isolators,” which is incorporated herein by reference in its entirety.

### STATEMENT OF GOVERNMENT SUPPORT

This invention was made with government support under W911NF-17-1-0312 awarded by the Army Research Laboratory-Army Research Office, and N00014-21-1-2770 awarded by the Office of Naval Research. The government has certain rights in the invention.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

An optical chiral router is a key component for optical interconnects, but its realization is fundamentally limited by the requirement of breaking the optical reciprocity. The magneto-optic effect can be utilized to break reciprocity but incorporating magnetic compounds with silicon-based integrated photonics is technically challenging. Alternatively, optical nonlinearity or spatiotemporal modulation of the dielectric environment has been exploited to bypass the reciprocity theorem. However, they often suffer from poor bandwidth or limited isolation efficiency.

### SUMMARY OF THE INVENTION

In various embodiments, the present disclosure describes novel on-chip non-magnetic chiral optical routers, where directional localization is introduced between a pair of light signals under time-reversal via dissipation engineering, allowing substantial reduction of back-reflection of chiral signals, similar to optical isolation without breaking reciprocity. The directional localization leads to the localization of wavefunctions of opposite chirality to opposite edges of an optical system, which is an example of the non-Hermitian skin effect (NHSE) referred to herein as a “chiral skin effect.” In examples, isolators herein are characterized by a loss that introduces a Z2 symmetry breaking. The broken Z2 symmetry leads to the skin localization (e.g., at the edges of an optical system) of the photonic wavefunction. The techniques herein enable directional transport of chiral signals without external spatiotemporal modulation or nonlinearity.

In various embodiments, we used coupled, silicon-compound photonic crystal nanocavities as meta-molecules to implement controlled non-Hermicity and on-chip unidirectional transport of light. The techniques here enable scalable, passive, high-performance, non-magnetic optical chiral router, for example, as may be used in any number of complementary metal-oxide-semiconductor (CMOS) compatible platforms.

In accordance with an embodiment, an optical device comprises: a pair of optical waveguide structures forming an optical chiral router, the pair of optical waveguide structures comprising, a first optical waveguide structure formed of a first set of photonic crystal nanocavities, a second optical waveguide structure formed of a second set of photonic crystal nanocavities, wherein the first optical waveguide structure is offset relative to the second optical waveguide structure to form auxiliary optical cavity modes, and one or more mirror regions positioned relative to the first optical waveguide structure and the second optical waveguide structure to induce a chiral skin effect based on loss-induced next-nearest neighbor coupling across the optical chiral router.

In accordance with yet another embodiment, a method for performing optical chiral routing in an optical circuit, the method comprises: feeding an optical signal into a pair of optical waveguide structures forming an optical chiral router, the pair of optical waveguide structures comprising a first optical waveguide structure formed of a first set of photonic crystal nanocavities and a second optical waveguide structure formed of a second set of photonic crystal nanocavities; coupling a portion of the optical signal into one or more auxiliary optical cavity modes formed by offsetting the first optical waveguide structure relative to the second optical waveguide structure; and inducing, via positioning one or more mirror regions relative to the first optical waveguide structure and the second optical waveguide structure, a chiral skin effect across the optical isolator for affecting propagation of the optical signal.

In various of the foregoing embodiments, the first set of photonic crystal nanocavities and the second set of photonic crystal nanocavities are formed of circular nanocavities.

In accordance with yet another embodiment, an optical device comprises: a first optical ring resonator structure and a second optical ring resonator each formed of a plurality of nanoring resonators, where the first optical ring resonator structure and the second optical ring resonator structure are positioned relative to one another to from an optical interconnect having a first optical end and a second optical end; and an auxiliary ring resonator structure formed of a plurality of nanoring resonators, the auxiliary ring resonator structure being positioned for optical mode coupling with the first optical ring resonator structure and with the second optical ring resonator structure, wherein the auxiliary ring resonator is configured to induce a difference in optical loss on light propagating in the optical interconnect from the first optical end to the second optical end compared to the light propagating in the optical interconnect from the second optical end to the first optical end.

In accordance with yet another embodiment, a method for performing optical chiral routing in an optical circuit, the method comprises: feeding an optical signal into an optical interconnect having a first optical end and a second optical end, the optical interconnect being formed of a first optical ring resonator structure and a second optical ring resonator each formed of a plurality of nanoring resonators; and inducing a difference optical loss on the optical signal propagating in the optical interconnect from the first optical end to the second optical end compared to the optical signal propagating in the optical interconnect from the second optical end to the first optical end, by positioning an auxiliary ring resonator structure, formed of a plurality of nanoring resonators, for optical mode coupling with the first optical ring resonator structure and with the second optical ring resonator structure.

In various of the foregoing embodiments, the auxiliary ring resonator structure has a rotational symmetry broken circular grating configuration.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1, depicts a schematic of the non-Hermitian modified Su-Schrieffer-Heeger model, in accordance with an example.

FIG. 2, depicts wavefunction distributions resulting from a chiral non-Hermitian skin effect, in accordance with an example.

FIG. 3 depicts a photonic non-Hermitian, Su-Schrieffer-Heeger chain, in accordance with an example.

FIG. 4 depicts photonic energy dispersion in a chiral router, according to some aspects, in accordance with an example.

FIG. 5 depicts a polarization-dependent chiral non-Hermitian skin effect, in accordance with an example.

FIGS. 6A and 6B depict a scanning electron microscopy (SEM) image of a preliminary photonic crystal device for the photon transport, in accordance with an example.

FIG. 7 depicts a schematic of an alternative non-Hermitian photonic device, in accordance with an example.

FIG. 8 depicts an FDTD simulation on the ring-resonator architecture, in accordance with an example.

FIG. 9 depicts an FDTD simulation of the non-Hermitian ring resonators, in accordance with an example.

FIG. 10 depicts a comparison of an example numerical validation of the techniques herein, in accordance with an example.

FIG. 11 depicts an SEM image of the preliminary photonic crystal device as well as a free-space measurement of the non-Hermitian skin effect and photon wavefunction leakage from different grating couplers in each device, in accordance with an example.

FIG. 12 depicts a flowchart of an example method for performing optical chiral routing in an optical circuit, in accordance with an example.

FIG. 13 depicts a flowchart of an example method for performing optical chiral routing in an optical circuit, in accordance with an example.

### DETAILED DESCRIPTION

In various embodiments, the present disclosure describes novel on-chip non-magnetic, passive, and linear optical skin effect device, where a chiral skin effect is introduced via dissipation engineering. The chiral skin effect is the localization of wavefunctions of opposite chirality to opposite edges of an optical system. In examples, skin effect devices herein are characterized by a loss that introduces an effective next-nearest neighbor coupling and Z2 symmetry breaking. The loss-induced next-nearest neighbor coupling leads to the skin localization of the photonic wavefunction. The techniques herein enable optical skin effect without external spatiotemporal modulation or nonlinearity.

In various embodiments, we used coupled, silicon-compound photonic crystal nanocavities as meta-molecules to implement controlled non-Hermicity and on-chip unidirectional transport of light. The techniques here enable scalable, passive, high-performance, non-magnetic optical chiral router, for example, as may be used in any number of complementary metal-oxide-semiconductor (CMOS) compatible platforms.

### Example On-Chip Optical Chiral Router

As noted above, in various embodiments, a novel on-chip non-magnetic optical chiral router is provided where chirality-dependent mode localization is introduced via dissipation engineering. The localization of wavefunctions to an edge of the system is often referred to as the non-Hermitian skin effect. In various examples, we used coupled, silicon-compound photonic crystal nanocavities as meta-molecules to implement controlled non-Hermicity and on-chip unidirectional transport of light.

In various embodiments, we demonstrate a non-magnetic, on-chip optical chiral router by achieving a chiral skin effect based on loss-induced next-nearest neighbor coupling.

Recently discovered novel localization effects in an open system, namely, the non-Hermitian skin effect, could be utilized to demonstrate a chiral optical router. Unlike other localization effects, such as topological edge modes, the non-Hermitian skin effect features localization of extensive numbers of wavefunctions to a boundary of the system. It has been experimentally demonstrated from mechanical metamaterials and circuit QED that most of the eigenfunctions at different eigenfrequencies can be directionally localized. It is also demonstrated in a nanophotonic platform yet relies on manipulated anisotropic hopping, which requires complicated and large additional components. In this regard, a facile nanophotonic implementation of a non-Hermitian skin effect that does not require complex structures is desirable.

The present application describes novel approaches where loss introduces linear, magnet-free, and fully passive non-Hermitian skin effect. The loss induced next-nearest-neighbor coupling leads to the chiral skin effect. In various examples, these approaches enable non-Hermitian skin effect in a wide bandwidth without external spatiotemporal modulation or nonlinearity.

### Loss-Induced Chiral Non-Hermitian Skin Effect

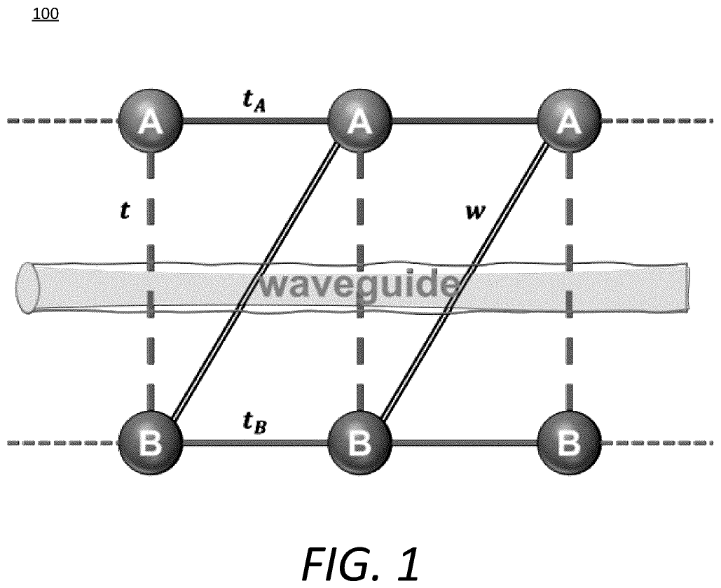

In an example, techniques herein can be modeled as a Su-Schrieffer-Heeger chain coupled with auxiliary modes. FIG. 1 depicts a schematic description of a non-Hermitian modified Su-Schrieffer-Heeger model 100 with large A-A and B-B coupling (coefficient t_{A}, t_{B}), weak direct A-B coupling (coefficient t and w), but strong A-B coupling through a waveguide modeled as auxiliary modes. To construct such a model with loss-induced next-nearest neighbor coupling, a pair of auxiliary modes is needed to create a closed path for effective magnetic flux, as shown in FIG. 1. A pair of cavities or waveguides can introduce auxiliary modes. Two auxiliary modes are set orthogonal to construct the magnetic flux imbalance while their loss differs. The real space Hamiltonian in a Hermitian limit, neglecting the lossy auxiliary modes, reads as follows:

$${H}_{0} = {\sum }_{i} {tc}_{i , A}^{†} {c}_{i , B} + {wc}_{i , B}^{†} {c}_{i + 1 , A} + Δ ( {c}_{i , A}^{†} {c}_{i , A} - {c}_{i , B}^{†} {c}_{i , B} ) + {t}_{A} {c}_{i , A}^{†} {c}_{i + 1 \cdot A} + {t}_{B} {c}_{i , B}^{†} {c}_{i + 1 \cdot B} + h . c .. \qquad ( 1 )$$

Creation and annihilation operators for the i-th auxiliary sites in the model 100 are denoted as

$${c}_{{\pm }_{i}}^{†}$$

and c_{±}_{ᵢ} in the Hamiltonian, respectively.

$${a}_{i}^{†} ( {a}_{i} ) and {b}_{i}^{†} ( {b}_{i} )$$

are creation (annihilation) operators for the A and B sites. All the coupling constants are illustrated in FIG. 1. This Hamiltonian respects reciprocity, exhibiting no wavefunction localization. In a non-Hermitian regime, where a lossy waveguide is imposed, A and B sites couple through the lossy waveguide. In the simplified limit of t=w=Δ=0, t_{A}=t_{B}=1, and loss rate γ, performing the transformation in the momentum space c_{k,+}=(c_{k,A}±i c_{k,B})/√2 and integrating out the auxiliary site, the resulting non-Hermitian Hamiltonian in momentum space has the following minimal form:

$${H}_{non - Herm .} = {\sum }_{k} {c}_{k , \pm }^{†} {c}_{k , \pm } ( 2 {t}_{0} cos k \pm 2 i γsin k ) . \qquad ( 2 )$$

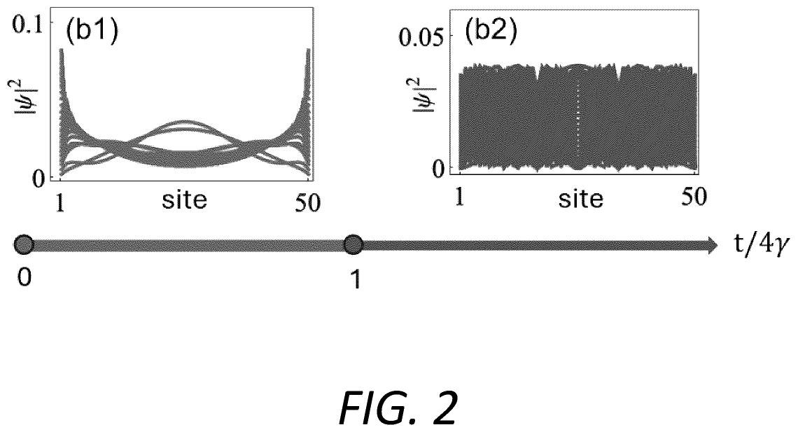

Here, γ is on-site loss on an auxiliary site, which gives rise to the non-Hermicity. The Hamiltonian respects Z2 reciprocity, which ensures an emergence of Z2 skin effect. In a more realistic photonic systems, t≠0. This breaks Z2 reciprocity, but still keeps TRS. Therefore, this model gives rise to the non-Hermitian skin effect in a fully passive, magnet-free, and linear photonic setting. FIG. 2 illustrates the wavefunction distributions of the Hamiltonian in different regimes. Graph b1 illustrates the varying localization distribution of the wavefunction when t is sufficiently small t<4γ (t<4γ). In this regime, the wavefunction shows localizations to the edges of the system. Graph b2 illustrates open boundary wavefunction distribution when the t is sufficiently large t>4γ. This condition largely breaks Z2 symmetry. Therefore, it does not feature non-Hermitian skin effect, and the wavefunction does not show localization. The chiral skin effect is induced only by the loss and next-nearest-neighbor coupling in this model.

Example On-Chip Optical Chiral Router: Coupled Photonic Crystal Nanobeam Cavities with Asymmetric Mirrors

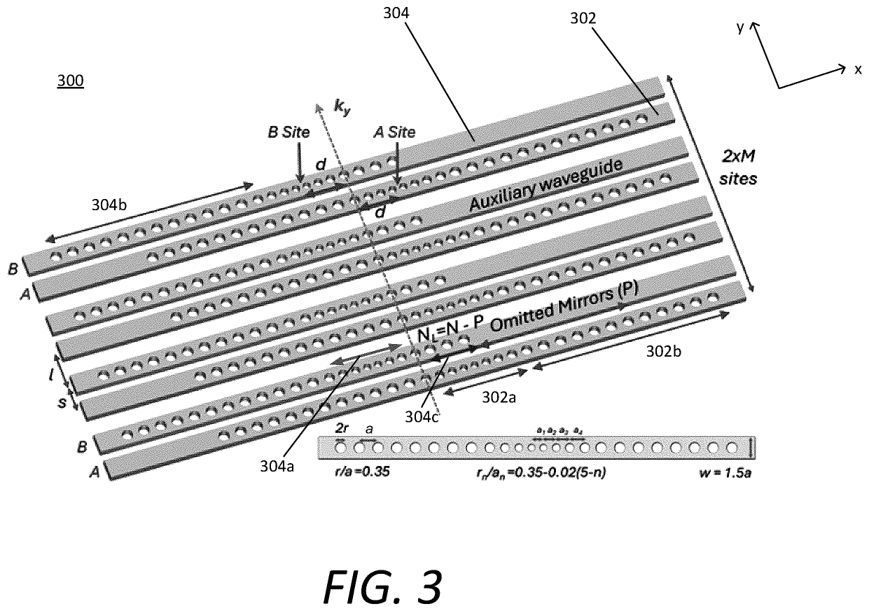

In an example device exhibiting loss-induced chiral skin effect, we formed an optical device of coupled photonic crystal nanobeam cavities (PCNCs) that exhibited photonic isolation. In particular, we developed an optical device with PCNCs forming asymmetric mirrors that embed an out-coupling waveguide that essentially supports incoming and outgoing auxiliary modes. These PCNCs can also mimic photonic meta-molecules with non-Hermicity. As we determined, a small number of mirrors on one side of PCNC can implement loss by reducing the Q factor, giving rise to non-Hermicity. FIG. 3 illustrates an implementation of this. FIG. 3 illustrates a photonic non-Hermitian Su-Schrieffer-Heeger chain device 300. Each A site 302 and B site 304 is a photonic crystal nanobeam cavity (PCNC). The A sites 302 comprise nanophotonic cavity regions 302a with modulated photonic crystals accompanied by periodic mirror regions 302b on both sides of the cavities (i.e., on either side of a centerline indicated by axis k_{y}) to make each A site 302 high Q. The mirror regions 302b each include N nanoholes. The B sites 304 are similar photonic crystal nanobeam cavities comprising nanophotonic cavity regions 304a and periodic mirror regions 304b. The mirror regions 304b include N nanoholes. In the B sites 304, a portion P of the N mirrors in the mirrors regions 304b are omitted on one side of the centerline, leaving a shortened mirror region 304c containing N_{L}=N−P mirrors. Omitting a portion P of the mirrors introduces loss and an auxiliary waveguides simultaneously, as the region of B site 304 without any nanoholes (i.e., a region which is neither a nanophotonic cavity region 304a nor a mirror region 304b or 304c) becomes a waveguide. Larger values for N and P (i.e., longer mirror regions 302b and 304b) induce high reflectivity and therefore high optical Q and small loss.

In the device 300, lengths I and s as shown on FIG. 3 are l=0.9a and s=0.7a, where a is the distance between two nanoholes in a mirror region 302b or 304b. However, any suitable values for I and s may be chosen, and different values could provide a similar result.

We implemented the tight-binding model by placing two PCNCs in a unit cell, namely A and B sites. (see, FIGS. 1 and 3) The cavities are arranged in a zig-zag pattern, e.g., having the A sites 302 shifted to the right from the center coordinate indicated by axis k_{y} and the B sites 304 shifted to the left from the center coordinate. Such a configuration allows A site 302 cavity modes to couple with B site 304 auxiliary waveguide, which is the key component enabling a chiral skin effect. The leakage from a low Q B site couples to the auxiliary waveguide and eventually dissipates to the outer environment.

### Numerical Validation

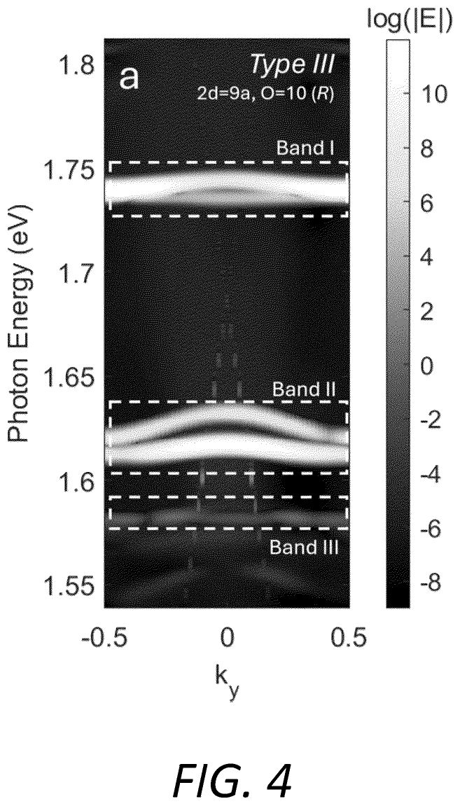

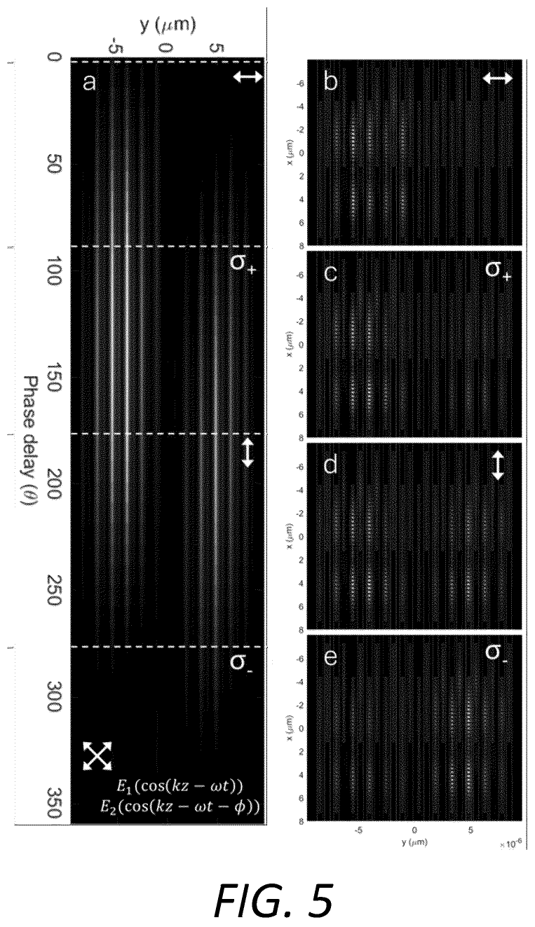

We numerically confirmed the chiral skin effect using the finite-difference-time domain (FDTD) method. We examined the chiral skin effect from the coupled PCNCs of FIG. 3 by computing photonic mode dispersions. FIG. 4 illustrates the FDTD simulation of photonic energy dispersion of the non-Hermitian Su-Schrieffer-Heeger chain when both loss and auxiliary waveguide is implemented (P=10). All the simulations are 2d=9a (a=320 nm), N=15, M=12, and the material is set to Silicon Nitride. It is shown that the photonic crystal dispersion is y-asymmetric, indicating the next-nearest neighbor coupling, namely, A-A and B-B coupling, dominates A-B coupling. Therefore, the system is expected to exhibit chiral skin effect. The consequence of the next-nearest neighbor coupling is also clearly manifested in an open-boundary simulation where unidirectional transport of chiral modes is observed, as discussed with respect to FIG. 5 below.

FIG. 5 depicts a numerical demonstration of chiral skin effect over an entire skin effect device. All of the figures show the absolute value of Ey field distributions. Each figure is an open boundary example that corresponds to the configurations presented in FIG. 4. FIG. 5 illustrates an electric field distribution of non-Hermitian Su-Schrieffer-Heeger chain with embedded auxiliary waveguides and loss, exhibiting chiral localization. (P=10, 2d=9, N=15) The open boundary FDTD simulation is performed on a 12-period (M=12) photonic lattice. The localization direction and the strength can be controlled by the excitation polarization. For instance, the circular+light excites the bottom localizing skin mode. Whereas the circular−light excites the upper localizing skin mode.

### Device Fabrication

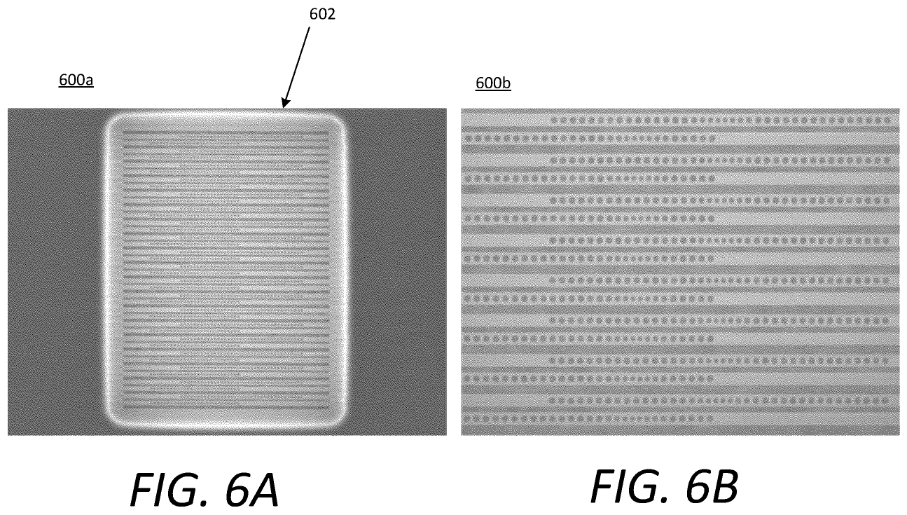

FIG. 6A illustrates a scanning electron microscopy (SEM) image 600a of a photonic crystal device 602 fabricated on a silicon nitride film on a silicon wafer in another example demonstration of the photon transport achievable with the techniques herein. FIG. 6B illustrates a close-up view 600b of part of the device 602. The device 602 was fabricated by the cleanroom facility at Lurie Nanofabrication Facility at the University of Michigan. We used Low-Pressure Chemical Vapor Deposition of the silicon nitride film, E-Beam lithography, plasma etch, XeF2 deep Si etch, and other metrology tools. The photonic crystal device 602 may be similar to the photonic non-Hermitian Su-Schrieffer-Heeger chain device 300 shown in FIG. 3.

### Example—Coupled Ring-Resonators with Symmetry-Broken Auxiliary Resonators

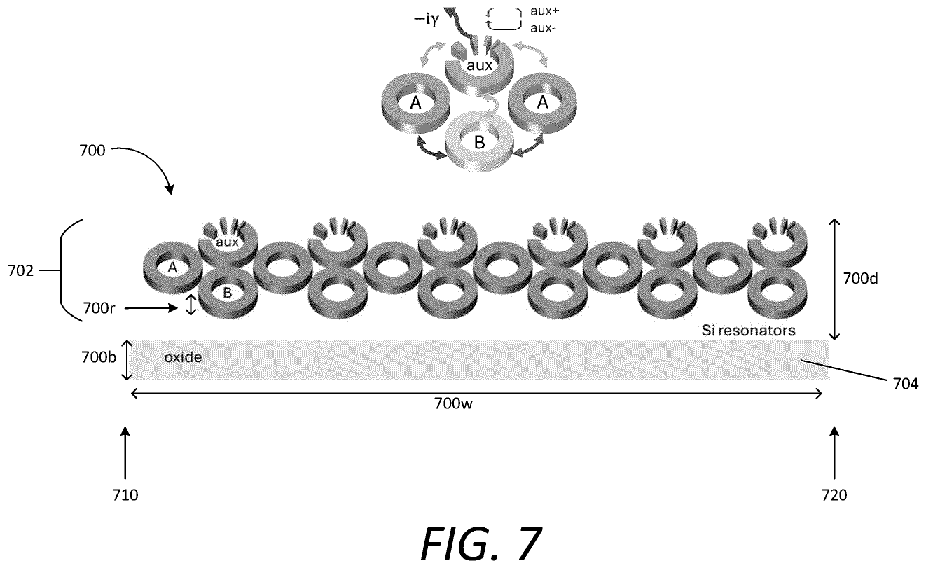

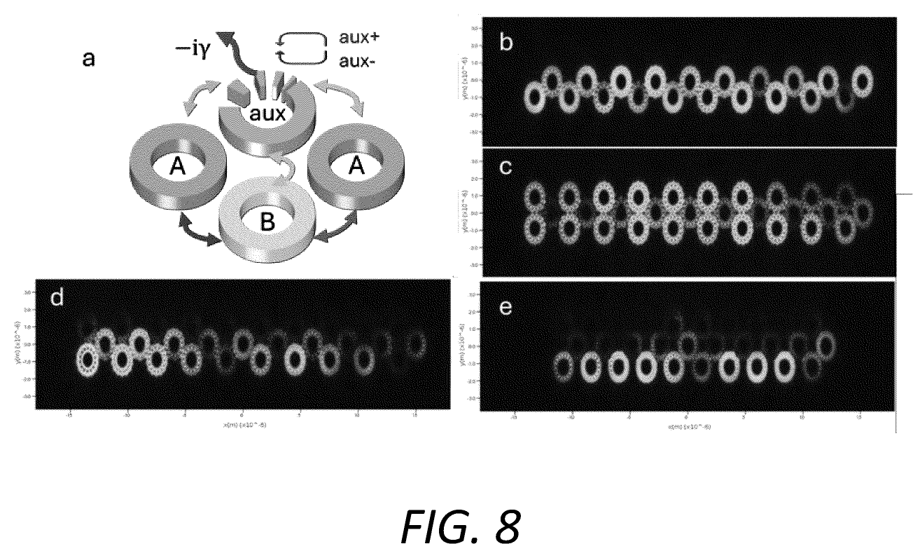

In various embodiments, the present techniques are implemented using coupled ring-resonators. For example, FIG. 7 illustrates an isometric view of an alternative non-Hermitian photonic device 700, which may be called an optical interconnect, and which has a width 700w, a depth 700d, a base height 700b, and a resonator height 700r. The photonic device 700 employs a coupled-resonator scheme with ring resonators, such as nanoring resonators. The photonic device 700 includes a first optical end 710 and a second optical end 720. In particular, in the illustrated example, the device 700 is formed of A sites, B sites, and Aux sites, each of which are optical resonators and may be optically coupled together for a inducing a directional asymmetry in the optical loss of the optical signal propagating in the photonic device 700. In other words, a different optical loss occurs in the optical signal propagating from the first optical end 710 to the second optical end 720 as compared to the optical loss that occurs in the optical signal propagating from the second optical end 720 to the first optical end 710. In the illustrated example, each site (A, B, and Aux) may be a silicon ring resonator, collectively the Si resonators 702, formed on a silicon oxide layer 704. A and B sites, which themselves may be optically coupled together, are optically coupled to auxiliary resonators that introduce non-Hermicity. The auxiliary resonators include asymmetric grating arcs that give rise to different loss rates for clockwise and counterclockwise modes. In this configuration, auxiliary ring resonators are provided with asymmetric circular grating to implement the two orthogonal auxiliary modes with different losses. As used herein, the term asymmetric (circular) grating may be considered as including a rotational symmetry broken circular grating, by way of example. The counterclockwise mode of the A site resonators couple with clockwise mode of the B site resonators. Both modes couple with the auxiliary sites but experience different loss rates due to the asymmetric gratings. (see, FIG. 7 and FIG. 8(a)) The broken rotational symmetry gives different loss for clockwise and counterclockwise modes of the auxiliary ring resonators.

### Numerical Validation

As an initial validation of the techniques herein, we show the presence of skin mode from a numerical FDTD modeling of the structure. FIG. 8 illustrates an FDTD simulation on the ring-resonator architecture. FIG. 8(a) is a schematic description of the coupling configuration in the ring-resonator scheme. FIGS. 8(b), 8(c), 8(d) and 8(e) show the electric field distribution of the structure (b) when there are no auxiliary resonators, (c) when the auxiliary resonators are coupled while the asymmetric gratings are not implemented, (d) when the asymmetric gratings are implemented, and (e) when the asymmetric gratings are implemented but the coupling between B site resonators and auxiliary resonators are not coupled. (q=0) All the simulations used randomly distributed, polarized, and phased multiple dipoles. We assume silicon ring resonators with an oxide layer underneath to adapt to the complementary photonic integration technologies. For the simulation, 10 periods of unit cells are assumed. To validate the presence of skin mode, we compare four representative settings as follows.
A. 1d chain of coupled A and B ring resonators.
B. Adding to “a” auxiliary cavities that couple with both A and B sites, but without loss.
C. Adding to “a” auxiliary cavities that couple with both A and B sites, and with asymmetric loss between counterclockwise and clockwise modes.
D. Adding to “a” auxiliary cavities with asymmetric loss, but only couple with A sites, with negligible coupling with B sites.

The A. and B. settings above are expected to exhibit no skin localization, which is clearly manifested in FIG. 8(b) and FIG. 8(c). When the auxiliary resonators with embedded asymmetric grating are introduced and simultaneously couple with both A and B sites, a clear skin mode emerges. (see FIG. 8(d) and FIG. 8(e)) Note that the skin mode resonance is taken at ˜1340 nm. The mode resonance can be easily tuned by tailoring the outer and inner diameters of the resonators to desired wavelengths.

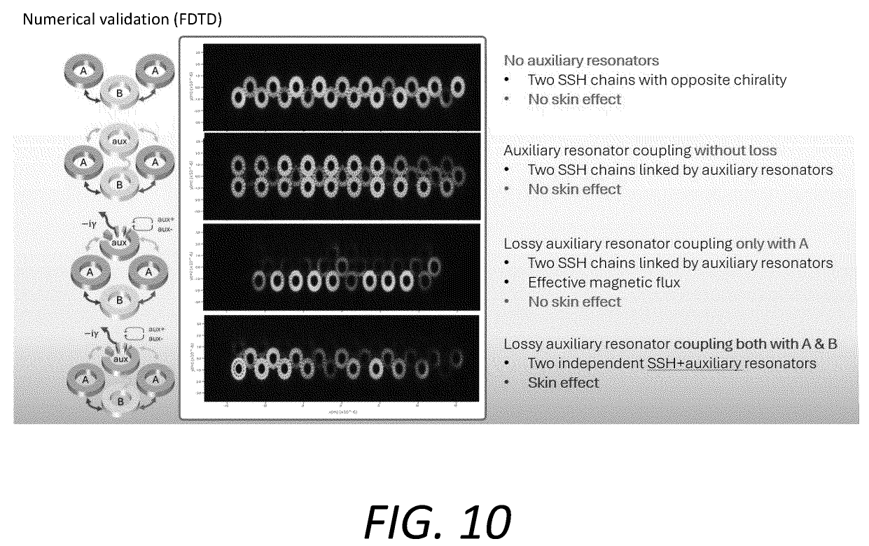

FIG. 10 illustrates a comparison of an example numerical validation of the techniques herein, comparing no auxiliary resonators (two Su-Schrieffer-Heeger (SSH) chains AB and BA), auxiliary resonator coupling without loss (two SSH chains AB and BA linked with an auxiliary resonator coupled to A and B sites), loss auxiliary resonator coupling with only A coupling (two SSH chains AB and BA with a lossy auxiliary resonator coupling to only A sites), and a lossy auxiliary resonator with both A and B coupling (two SSH chains AB and BA linked with a lossy auxiliary resonated coupled to A and B sites).

### Performance Evaluation

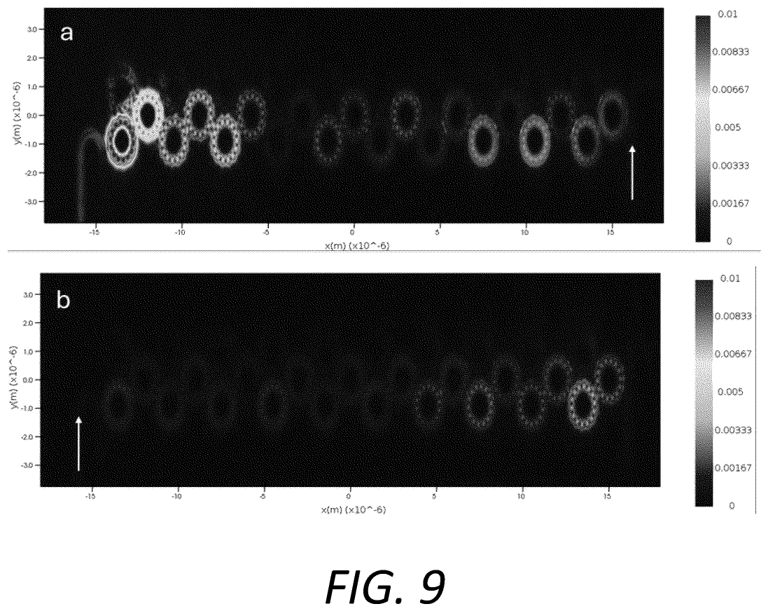

FDTD modeling was used to assess the key performance of the non-Hermitian optical chiral router. FIG. 9 illustrates an FDTD simulation of the non-Hermitian ring-resonators. The white arrows indicate the position and direction of the input mode source. Note that the color scale for both figures is the same. The electric field profiles are taken at the same resonance frequency. FIG. 9(a) shows that when the device is excited by the right port generating momentum toward −x, skin mode is clearly excited. FIG. 9(b) shows that when the left port is excited generating momentum toward +x direction, no clear skin mode is observed. Due to the broken reciprocity, the group velocity toward +x direction experiences large dissipation, resulting in much weaker intensity. Two waveguide couplers were placed on both ends of the ring resonator chain as input/output ports. The end of the ports reaches the end of the simulation boundary, which is set to be perfectly matched layers. The boundary in the simulation functions as a perfect absorber, so that back reflection from the edge of the waveguide does not affect the system. For an actual device, it can be substituted by a carefully designed grating out coupler. It is worth noting that the ports excite counterclockwise mode for the A site resonators while the B site resonators are clockwise excited. The auxiliary sites are excited for the both modes that may experience different loss rate due to the asymmetric gratings.

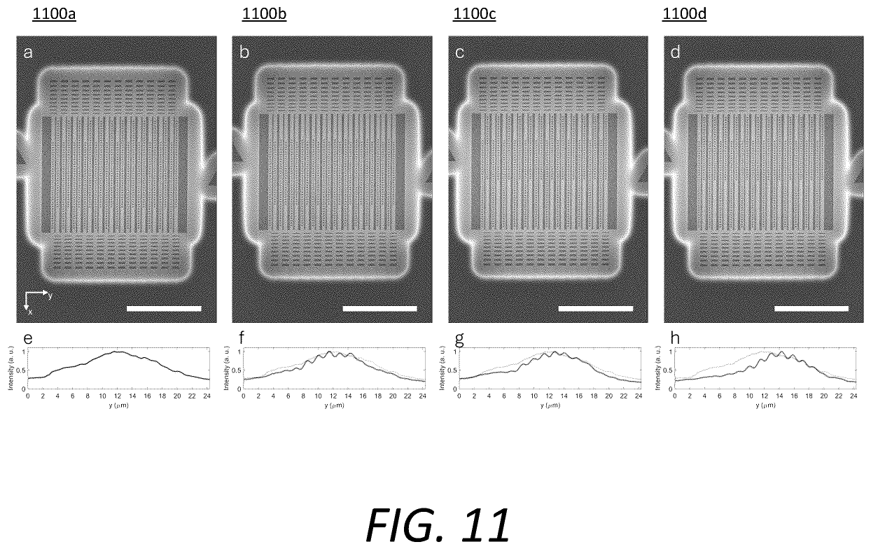

FIG. 11 illustrates SEM images 1100a, 1100b, 1100c, and 1100d of the preliminary photonic crystal device as well as a free-space measurement of the chiral non-Hermitian skin effect and photon wavefunction leakage from different grating couplers in each device. As shown, non-Hermitian chains with large-cavity waveguide coupling exhibit NHSE.

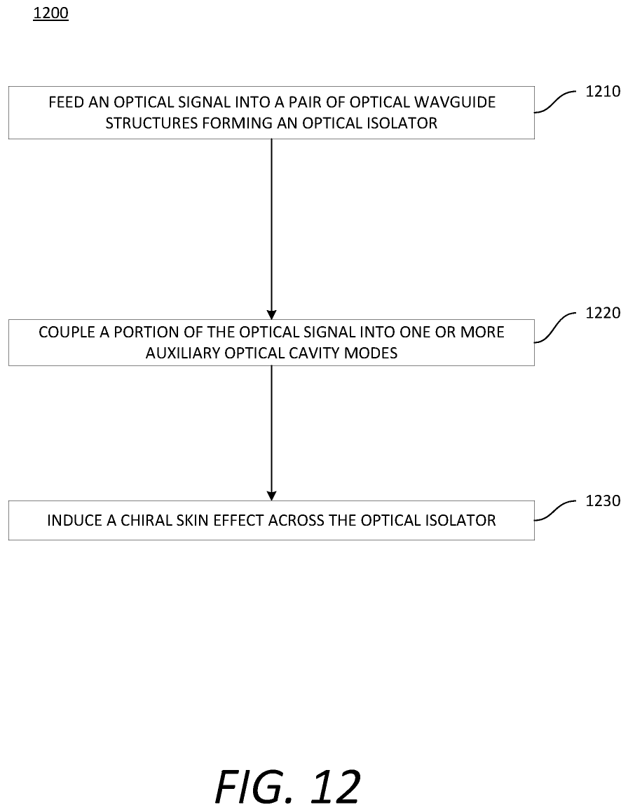

FIG. 12 illustrates a flowchart of an example method 1200 for performing optical chiral routing in an optical circuit according to the present invention. At step 1210, an optical signal is fed into a pair of optical waveguides forming an optical router. The pair of optical waveguide structures comprises a first optical waveguide structure formed of a first set of photonic crystal nanocavities and a second optical waveguide structure formed of a second set of photonic crystal nanocavities. The pair of optical waveguide structures may be, for example, a portion of the photonic non-Hermitian Su-Schrieffer-Heeger chain device 300 shown in FIG. 3 or a portion of the photonic crystal device 602 shown in FIG. 6A.

At step 1220, a portion of the optical signal is coupled into one or more auxiliary optical cavity modes. The one or more auxiliary cavity modes are formed by offsetting the first optical waveguide structure relative to the second optical waveguide structure such that the photonic crystal nanocavities in the first optical waveguide structure are offset relative to the photonic crystal nanocavities in the second optical waveguide structure as shown in, for example, FIG. 3.

At step 1230, a chiral skin effect for affecting propagation of the optical signal, is induced across the optical chiral router via positioning one or more mirror regions relative to the first optical waveguide structure and the second optical waveguide structure. The one or more mirror regions may comprise a first mirror region extending at least partially along both sides of the first optical waveguide structure and a second mirror region extending at least partially along only one side of the second optical waveguide structure. The first waveguide structure and the second waveguide structure are arranged relative to each other to form a plurality of cavities in a zig-zag configuration, each of the plurality of cavities being associated with one or more of the one or more auxiliary optical cavity modes.

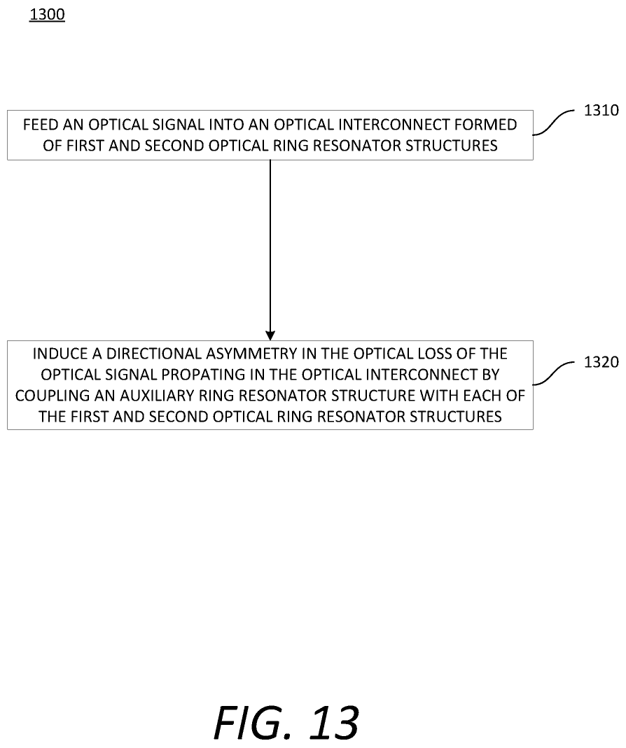

FIG. 13 illustrates a flowchart of an example method 1300 for performing optical chiral routing in an optical circuit according to the present invention. At step 1310, an optical signal is fed into an optical interconnect formed of a plurality of nanoring resonators. The optical resonator comprises a first optical ring resonator structure and a second optical ring resonator structure. Each ring resonator structure is formed of a plurality of nanoring resonators. The optical interconnect may be, for example, the non-Hermitian photonic device 700 shown in FIG. 7. The first optical ring resonator structure may be, for example, the A sites of the photonic device 700, and the second optical ring resonator structure may be the B sites of the photonic device 700.

At step 1320, a directional asymmetry is induced in the optical loss of the optical signal propagating in the optical waveguide. In other words, a different optical loss occurs in the optical signal propagating from the first optical end to the second optical end as compared to the optical loss that occurs in the optical signal propagating from the second optical end to the first optical end. The different optical loss is induced by positioning an auxiliary ring resonator structure for optical mode coupling with each of the first optical ring resonator structure and the second optical ring resonator structure. The auxiliary ring resonator structure is formed of a plurality of nanoring resonators. The auxiliary ring resonator structure may be, for example, the aux sites of the photonic device 700.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the target matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding; and no unnecessary limitations should be understood therefrom, as modifications within the scope of the invention may be apparent to those having ordinary skill in the art.

What is claimed:

1. An optical device comprising:
a pair of optical waveguide structures forming an optical chiral router, the pair of optical waveguide structures comprising,
a first optical waveguide structure formed of a first set of photonic crystal nanocavities,
a second optical waveguide structure formed of a second set of photonic crystal nanocavities, wherein the first optical waveguide structure is offset relative to the second optical waveguide structure to form auxiliary optical cavity modes, and
one or more mirror regions positioned relative to the first optical waveguide structure and the second optical waveguide structure to induce a chiral skin effect based on loss-induced next-nearest neighbor coupling across the optical chiral router.

2. The optical device of claim 1, wherein the first set of photonic crystal nanocavities and the second set of photonic crystal nanocavities are both formed of photonic crystal nanobeam cavities (PCNCs).

3. The optical device of claim 1, wherein the auxiliary optical cavity modes comprise an incoming auxiliary optical cavity mode and an outgoing auxiliary optical cavity mode of the optical chiral router.

4. The optical device of claim 1, wherein the one or more mirror regions comprises a first mirror region extending at least partially along both sides of the first optical waveguide structure and a second mirror region extending at least partially along only one side of the second optical waveguide structure.

5. The optical device of claim 1, wherein the first waveguide structure and the second waveguide structure are arranged relative to each other to form a plurality of cavities in a zig-zag configuration, each of the plurality of cavities being associated with one or more of the auxiliary optical cavity modes.

6. The optical device of claim 5, wherein the one or more mirror regions are positioned in an asymmetric manner across the plurality of cavities.

7. The optical device of claim 1, wherein the pair of optical waveguide structures are formed of silicon nitride.

8. The optical device of claim 1, wherein the first set of photonic crystal nanocavities and the second set of photonic crystal nanocavities are nanocavities fabricated in a silicon nitride film.

9. The optical device of claim 8, wherein the silicon nitride film is positioned on a silicon wafer and optically coupled to a CMOS optical circuit element at least partially positioned on the silicon wafer.

10. The optical device of claim 1, wherein the first set of photonic crystal nanocavities and the second set of photonic crystal nanocavities are formed of circular nanocavities.

11. The optical device of claim 1, wherein the first set of photonic crystal nanocavities and the second set of photonic crystal nanocavities are linear waveguides.

12. A method for performing optical chiral routing in an optical circuit, the method comprising:
feeding an optical signal into a pair of optical waveguide structures forming an optical chiral router, the pair of optical waveguide structures comprising a first optical waveguide structure formed of a first set of photonic crystal nanocavities and a second optical waveguide structure formed of a second set of photonic crystal nanocavities;
coupling a portion of the optical signal into one or more auxiliary optical cavity modes formed by offsetting the first optical waveguide structure relative to the second optical waveguide structure; and
inducing, via positioning one or more mirror regions relative to the first optical waveguide structure and the second optical waveguide structure, a chiral skin effect across the optical chiral router for affecting propagation of the optical signal.

13. An optical device comprising:
a first optical ring resonator structure and a second optical ring resonator each formed of a plurality of nanoring resonators, where the first optical ring resonator structure and the second optical ring resonator structure are positioned relative to one another to from an optical interconnect having a first optical end and a second optical end; and
an auxiliary ring resonator structure formed of a plurality of nanoring resonators, the auxiliary ring resonator structure being positioned for optical mode coupling with the first optical ring resonator structure and with the second optical ring resonator structure, wherein the auxiliary ring resonator is configured to induce a difference in optical loss on light propagating in the optical interconnect from the first optical end to the second optical end compared to the light propagating in the optical interconnect from the second optical end to the first optical end.

14. The optical device of claim 13, wherein the first optical ring resonator structure comprises a plurality of the nanoring resonators in a linear configuration.

15. The optical device of claim 14, wherein the second optical ring resonator structure comprises a plurality of the nanoring resonators in a linear configuration and is offset from the plurality of nanoring resonators of the first optical ring resonator structure.

16. The optical device of claim 13, the plurality of nanoring resonators of the auxiliary ring resonator structure each have a rotational symmetry broken circular grating configuration.

17. The optical device of claim 13, wherein the first optical ring resonator structure, the second optical ring resonator structure, and the auxiliary ring resonator structure are each silicon ring resonators formed on a silicon oxide layer.

18. The optical device of claim 17, wherein the silicon oxide layer is formed at least partially on a silicon wafer and optically coupled to a CMOS optical circuit element at least partially positioned on the silicon wafer.

19. A method for performing optical chiral routing in an optical circuit, the method comprising:
feeding an optical signal into an optical interconnect having a first optical end and a second optical end, the optical interconnect being formed of a first optical ring resonator structure and a second optical ring resonator each formed of a plurality of nanoring resonators; and
inducing a difference optical loss on the optical signal propagating in the optical interconnect from the first optical end to the second optical end compared to the optical signal propagating in the optical interconnect from the second optical end to the first optical end, by positioning an auxiliary ring resonator structure, formed of a plurality of nanoring resonators, for optical mode coupling with the first optical ring resonator structure and with the second optical ring resonator structure.

20. The method of claim 19, wherein the auxiliary ring resonator structure has a rotational symmetry broken circular grating configuration.
